(19) United States
(12) Patent Application Publication
(10) Pub. No.: US 2016/0076395 A1
(43) Pub. Date: Mar. 17, 2016

(54) METHOD OF MANUFACTURING ICE PANEL SEGMENTS

(71) Applicant: United Technologies Corporation, Hartford, CT (US)

(72) Inventors: Steven Clarkson, Cheshire, CT (US); Mark W. Costa, Storrs, CT (US)

(73) Assignee: United Technologies Corporation, Hartford, CT (US)

(21) Appl. No.: 14/946,175

(22) Filed: Nov. 19, 2015

Related U.S. Application Data
(63) Continuation of application No. PCT/US2014/052924, filed on Aug. 27, 2014.
(60) Provisional application No. 61/877,157, filed on Sep. 12, 2013.

(51) Int. Cl. F01D 25/02; B29C 70/06; B29C 65/00; F01D 25/24

(52) U.S. Cl. CPC F01D 25/02; F01D 25/24; B29C 70/06; B29C 65/00; F05D 2220/36; F05D 2230/30; B29K 2063/00

(57) ABSTRACT

The present disclosure relates to methods of manufacturing ice panel segments for turbofan engines. An ice panel material may be wrapped around a mandrel. The ice panel material may include an inner fiberglass layer, a plurality of KEVLAR® layers, and an outer fiberglass layer. The ice panel material may be bagged and cured into a rigid molded cylinder. The rigid molded cylinder may be radially cut into ice panel cylinders. The ice panel cylinders may be axially cut into ice panel segments. The ice panel segments may be bonded to an inner surface of a fan case.

### CROSS-REFERENCE TO RELATED APPLICATIONS

This application is a continuation of, claims priority to and the benefit of, PCT/US2014/052924 filed on Aug. 27, 2014 and entitled “METHOD OF MANUFACTURING ICE PANEL SEGMENTS,” which claims priority from U.S. Provisional Application No. 61/877,157 filed on Sep. 12, 2013 and entitled “METHOD OF MANUFACTURING ICE PANEL SEGMENTS.” Both of the aforementioned applications are incorporated herein by reference in their entirety.

### FIELD OF INVENTION

The present disclosure relates generally to turbine engines, and more particularly, the present disclosure relates to fan cases for turbofan engines.

### BACKGROUND OF THE INVENTION

A turbofan engine, such as those used in modern aircraft, typically includes a fan, a compressor, a combustion section, and a turbine. The fan may be located within a fan case and may comprise a plurality of fan blades coupled to a hub. At low temperatures and/or high altitudes, ice may accumulate on the fan blades. As the fan rotates at high angular velocities, the ice may release from the fan blades and contact an inner surface of the fan case at high speeds. The ice may cause damage to an unprotected fan case. In order to protect the fan case, ice panel segments may be bonded to an inner surface of the fan case. The ice panel segments may be individually manufactured and molded to match the geometry of the inner surface of the fan case.

### SUMMARY OF THE INVENTION

A method of manufacturing an ice panel segment is disclosed. The method may comprise wrapping an ice panel material around a mandrel. An outer surface of the mandrel may correspond to an inner surface of a fan case. The ice panel material may be cured, and the ice panel material may be cut into ice panel segments. Wrapping the ice panel material around the mandrel may comprise wrapping an inner fiberglass layer around the mandrel, wrapping a KEVLAR® layer around the inner fiberglass layer, and wrapping an outer fiberglass layer around the KEVLAR® layer.

A method of manufacturing ice panel segments is disclosed. The method may include providing an ice panel material. The ice panel material may be formed into a cylinder. The cylinder may be cut into ice panel segments. The cylinder may be formed from the ice panel material by wrapping the ice panel material around a mandrel.

A method of protecting a fan case is disclosed. The method may comprise cutting an ice panel cylinder into ice panel segments. The segments may be bonded to an inner surface of the fan case. The ice panel segments may be formed by wrapping an ice panel material around a mandrel.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures, wherein like numerals denote like elements.

FIG. 1 illustrates a schematic axial cross-section view of a gas turbine engine according to various embodiments;

FIG. 2 illustrates a perspective view of a front portion of a gas turbine engine according to various embodiments;

FIG. 3 illustrates a perspective view of a fan case according to various embodiments;

FIGS. 4A-4C illustrate a series of steps in manufacturing ice panel segments according to various embodiments; and

FIG. 5 illustrates a flow chart of a process for manufacturing ice panel segments according to various embodiments.

### DETAILED DESCRIPTION

The detailed description of exemplary embodiments herein makes reference to the accompanying drawings, which show various embodiments by way of illustration. While these various embodiments are described in sufficient detail to enable those skilled in the art to practice the disclosure, it should be understood that other embodiments may be realized and that logical, chemical, and mechanical changes may be made without departing from the spirit and scope of the disclosure. Thus, the detailed description herein is presented for purposes of illustration only and not of limitation. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected, or the like may include permanent, removable, temporary, partial, full, and/or any other possible attachment option. Additionally, any reference to without contact (or similar phrases) may also include reduced contact or minimal contact.

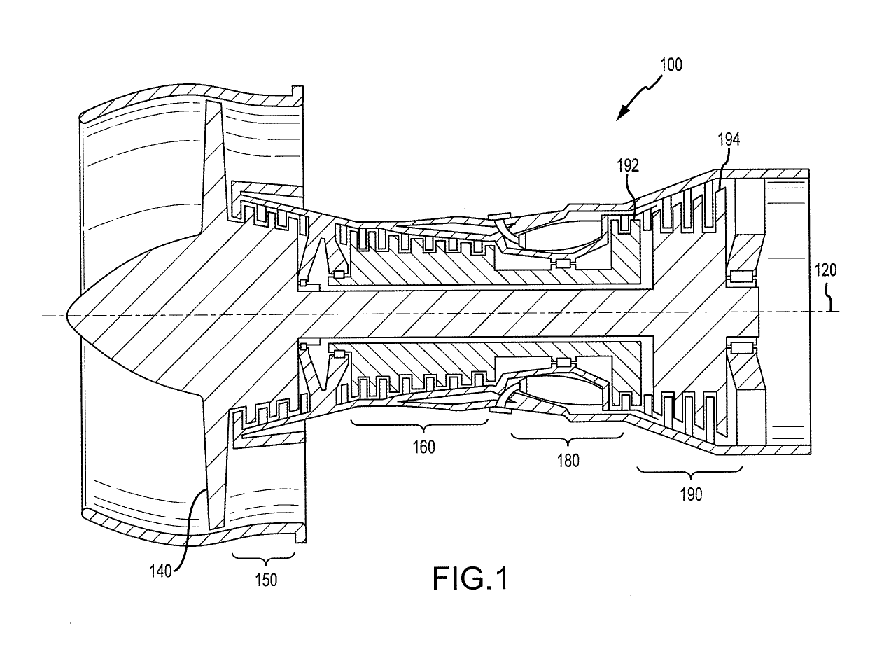

Referring to FIG. 1, a gas turbine engine 100, such as a turbofan engine, is illustrated according to various embodiments. Gas turbine engine 100 is disposed about axial centerline axis 120, which may also be referred to as axis of rotation 120. Gas turbine engine 100 may comprise a fan 140, compressor sections 150 and 160, a combustion section 180, and a turbine section 190. Air compressed in the compressor sections 150, 160 may be mixed with fuel and burned in combustion section 180 and expanded across turbine section 190. Turbine section 190 may include high pressure rotors 192 and low pressure rotors 194, which rotate in response to the expansion. Low pressure rotors 194 may be coupled to fan 140 via a shaft, causing fan 140 to rotate. FIG. 1 provides a general understanding of the sections in a gas turbine engine, and is not intended to limit the disclosure.

The forward-aft positions of engine 100 lie along axis of rotation 120. For example, fan 140 may be referred to as forward of turbine section 190 and turbine section 190 may be referred to as aft of fan 140. Typically, during operation of gas turbine engine 100, air flows from forward to aft, for example, from fan 140 to turbine section 190. As air flows from fan 140 to the more aft components of gas turbine engine 100, axis of rotation 120 may also generally define the direction of the air stream flow.

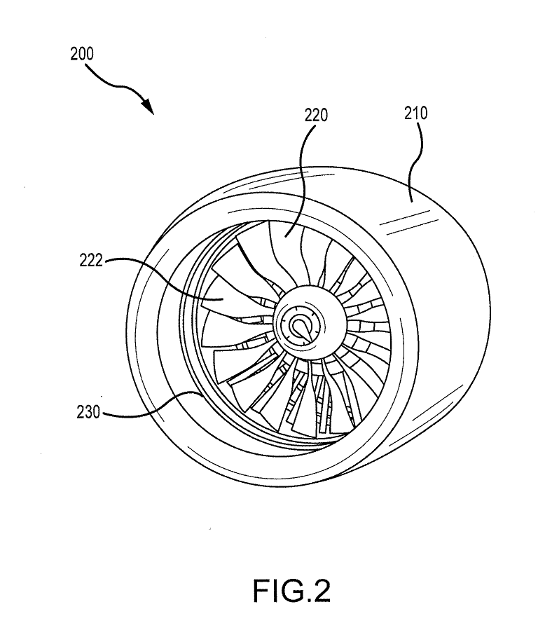

Referring to FIG. 2, a perspective view of a front portion of a gas turbine engine 200 is illustrated according to various embodiments. Gas turbine engine 200 may comprise nacelle 210, fan 220, and fan case 230. Fan 220 may comprise fan blades 222. Fan case 230 may be coupled to a radially inner portion of nacelle 210.

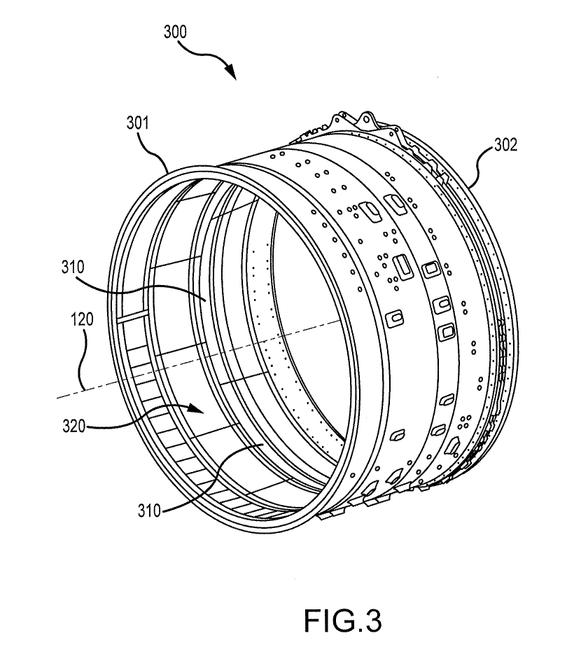

Referring to FIG. 3, a perspective view of a fan case 300 is illustrated according to various embodiments. In various embodiments, fan case 300 may be substantially cylindrical. Axial centerline axis 120 may generally define the direction of airflow through fan case 300 from forward end 301 to aft end 302. A plurality of ice panel segments 310 may be coupled to an inner surface 320 of fan case 300. Each ice panel segment 310 may comprise a portion of a cylinder. For example, as illustrated in FIG. 3, each ice panel segment 310 comprises a sixty degree arc forming a portion of a cylinder. The plurality of ice panel segments 310 may form a complete cylinder located within fan case 300. Each ice panel segment 310 may be individually installed in fan case 300. In various embodiments, ice panel segments 310 may be bonded to inner surface 320 of fan case 300.

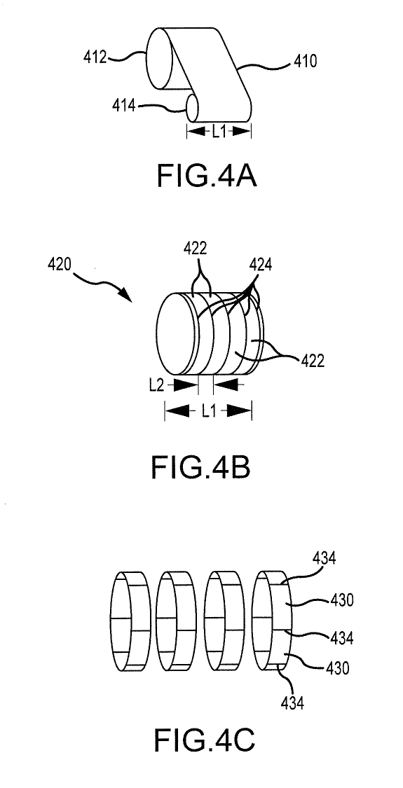

Referring to FIGS. 4A to 4C, a series of steps for manufacturing ice panel segments 430 is illustrated according to various embodiments. Referring to FIG. 4A, ice panel material 410 may be wound onto a mandrel 412. In various embodiments, mandrel 412 may be a tool with an outer profile which comprises substantially the same size and shape as an inner surface of a fan case in the region of a fan. For example, in various embodiments, a fan case may be substantially cylindrical and comprise a 90 inch inside diameter, and similarly mandrel 412 may be substantially cylindrical and comprise a 90 inch outside diameter, such that material wrapped onto mandrel 412 may comprise substantially the same size and shape as the inner surface of the fan case. In various embodiments, an outside diameter of mandrel 412 may be slightly smaller than the inside diameter of the fan case in order to account for a thickness of ice panel segments 430. For example, in various embodiments, ice panel segments 430 may comprise a thickness of about 0.16 inches (0.406 cm), or about 0.08 inches (0.203 cm)-0.32 (0.812 cm) inches. Thus, in various embodiments, an outside diameter of mandrel 412 may be about 0.16 (0.406 cm) inches, or about 0.08 inches (0.203 cm)-0.32 (0.812 cm) inches less than an inside diameter of the fan case. In various embodiments, mandrel 412 may be designed to match any size and shape corresponding to an inner surface of a fan case.

Ice panel material 410 may comprise any material capable of protecting a fan case from an impact of ice shed from fan blades. For example, in various embodiments, ice panel material 410 may comprise a composite material. In various embodiments, ice panel material 410 may comprise a pre-preg, which may comprise a fibrous material and an epoxy. In various embodiments, ice panel material 410 may comprise a para-aramid synthetic fiber, such as KEVLAR®. In various embodiments, ice panel material 410 may comprise fiberglass, graphite carbon, or any type of resin-impregnated cloth.

In various embodiments, ice panel segments 430 may comprise a plurality of layers of ice panel material 410. For example, in various embodiments, ice panel segments 430 may comprise twenty layers of ice panel material 410. However, in various embodiments, ice panel segments 430 may comprise any number of layers of ice panel material 410, for example, from one layer to fifty layers. In various embodiments, different layers of ice panel segments 430 may be comprised of different materials. For example, in various embodiments, ice panel segments 430 may comprise a plurality of KEVLAR®/epoxy layers, with an inner fiberglass layer located radially inward from the KEVLAR®/epoxy layers, and an outer fiberglass layer located radially outward from the KEVLAR®/epoxy layers. KEVLAR® is a registered trademark of DuPont™ Company. In various embodiments, fiberglass may comprise advantageous bonding properties over KEVLAR®. Thus, by providing an outer fiberglass layer, ice panel segments 430 may be more effectively bonded to the inner surface of the fan case. However, in various embodiments, fiberglass may comprise biased fibers which may cause warping of ice panel segments 430. By providing a second fiberglass layer, such as the inner fiberglass layer, with fibers biased in a different direction than the fibers in the outer fiberglass layer, such as orthogonal, any warping caused by the outer fiberglass layer may be counteracted by the inner fiberglass layer. Additionally, the inner fiberglass layer may seal and protect the KEVLAR®/epoxy layers.

In various embodiments, mandrel 412 may be spun in order to wrap ice panel material 410 around mandrel 412. In various embodiments, a motor may spin mandrel 412. However, in various embodiments, mandrel 412 may be spun by manual power. Additionally, in various embodiments, mandrel 412 may remain stationary, and ice panel material 410 may be wrapped around a stationary mandrel 412.

In various embodiments, a tension may be applied to ice panel material 410 as it is wrapped onto mandrel 412. The tension may eliminate or decrease the necessity to perform intermediate vacuum debulking of ice panel segments 430. Intermediate vacuum debulking may refer to debulking which occurs several times throughout layup of ice panel materials. As subsequent layers of ice panel material 410 wrapped around mandrel 412 may compress relatively radially inner layers previously wrapped around mandrel 412, such intermediate vacuum debulking may not be required. In various embodiments, the applied tension may equate to about 14 psi, or about 12-16 psi of pressure on ice panel material 410, which may be equivalent to the pressure typically applied during intermediate vacuum debulking However, in various embodiments, the tension applied may be greater than or less than 14 psi in order to achieve a desired fiber-to-resin ratio in ice panel material 410.

In various embodiments, once all layers of ice panel material 410 have been wrapped around mandrel 412, ice panel material 410 may be vacuum bagged and cured. Vacuum bagging may remove trapped air and volatiles and assist in resin flow and densification of ice panel material 410. Curing may include placing the ice panel material 410 in an autoclave and heating ice panel material 410 and applying pressure until ice panel material 410 becomes a rigid molded cylinder 420 as shown in FIG. 4B.

In various embodiments, rigid molded cylinder 420 may be cut into ice panel cylinders 422 as shown by radial cuts 424. In various embodiments, an axial length L1 of rigid molded cylinder 420 may be greater than a desired axial length L2 of ice panel cylinders 422. For example, in various embodiments, ice panel material 410 may be provided in rolls 414 having axial length L1 equal to a first distance, for example, from about 12 inches (30 cm) to about 60 inches (152.4 cm) and, in various embodiments, 38 inches (96 cm). However, the desired axial length L2 of ice panel cylinders 422 may be to a second distance, for example, from about 6 inches (15 cm) to about 12 inches (30 cm) and, in various embodiments 9 inches (23 cm). Rigid molded cylinder 420 may therefore be cut into four ice panel cylinders 422. Thus, multiple ice panel cylinders 422 may be formed in a single cycle of winding and curing. However, in various embodiments, axial length L1 is equal to L2, such that only one ice panel cylinder 422 is formed by rigid molded cylinder 420, and rigid molded cylinder 420 is not required to be further cut to form ice panel cylinders 422.

In various embodiments, ice panel cylinders 422 may be cut into a plurality of ice panel segments 430 as shown by axial cuts 434, as illustrated in FIG. 4C. In FIG. 4C, each ice panel cylinder 422 is cut into six equal sixty degree ice panel segments 430. However, in various embodiments, ice panel cylinder 422 may be cut into any number of ice panel segments 430. As the number of ice panel segments 430 per ice panel cylinder 422 increases, the amount of labor required to install the ice panel segments 430 in a fan case may also increase. However, for large fan cases, a larger number of ice panel segments 430 may be required to ease handling of large components. Thus, in various embodiments, the number of ice panel segments 430 per ice panel cylinder 422 may be selected by balancing labor and handling requirements. After ice panel cylinders 422 have been cut into ice panel segments 430, ice panel segments 430 may be bonded to the inner surface of a fan case.

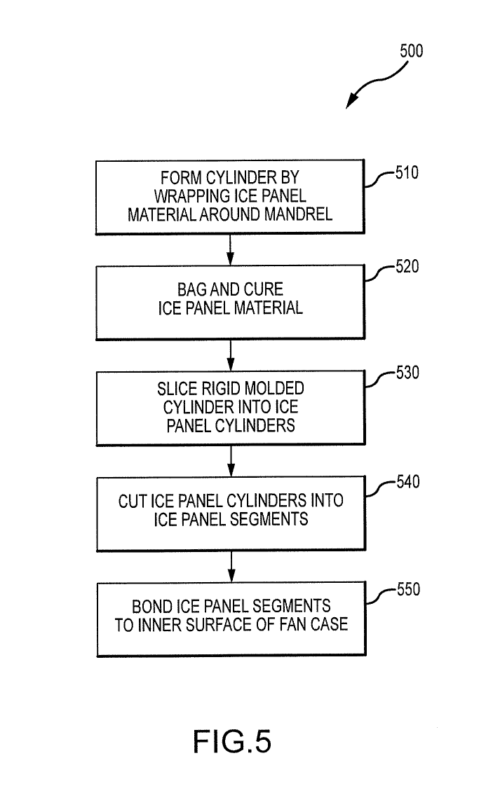

Referring to FIG. 5, a flowchart illustrating a process 500 for manufacturing ice panel segments is illustrated according to various embodiments. In various embodiments, a mandrel and an ice panel material may be provided. In various embodiments, a shape of an outer surface of the mandrel may correspond to a shape of an inner surface of a fan case. In various embodiments, the ice panel material may comprise a roll of a fiberglass composite and a roll of a KEVLAR®/epoxy composite. In various embodiments, the ice panel material may be formed into a cylinder by wrapping the ice panel material around the mandrel (step 510). Wrapping the ice panel material around the mandrel may comprise wrapping an inner fiberglass layer around the mandrel, wrapping a plurality of KEVLAR®/epoxy layers around the inner fiberglass layer, and wrapping an outer fiberglass layer around the plurality of KEVLAR®/epoxy layers. In various embodiments, a tension may be applied to the various layers wrapped around the mandrel.

In various embodiments, the ice panel material may be bagged and cured (step 520). Curing the ice panel material solidifies the ice panel material, creating a rigid molded cylinder. In various embodiments, the rigid molded cylinder may be sliced into a plurality of ice panel cylinders by one or more radial cuts (step 530). Each ice panel cylinder may be configured to fit within a fan case. Each ice panel cylinder may be further cut into ice panel segments by one or more axial cuts (step 540). However, in various embodiments, the rigid molded cylinder may be cut axially prior to being radially cut into ice panel cylinders. Once cut into ice panel segments, the ice panel segments may be bonded to an inner surface of a fan case (step 550).

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods and apparatus are provided herein. In the detailed description herein, references to “one embodiment”, “an embodiment”, “various embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A method of manufacturing an ice panel segment comprising:
wrapping an ice panel material around a mandrel;
curing the ice panel material; and
cutting the ice panel material into ice panel cylinders.

2. The method of claim 1, further comprising cutting the ice panel cylinders into ice panel segments.

3. The method of claim 2, wherein the ice panel material is cut radially into the ice panel cylinders, and wherein the ice panel cylinders are cut axially into the ice panel segments.

4. The method of claim 1, wherein the wrapping the ice panel material around the mandrel comprises spinning the mandrel.

5. The method of claim 1, wherein the wrapping the ice panel material around the mandrel comprises wrapping an inner fiberglass layer around the mandrel.

6. The method of claim 5, wherein the wrapping the ice panel material around the mandrel further comprises wrapping a KEVLAR® layer around the inner fiberglass layer.

7. The method of claim 6, wherein the wrapping the ice panel material around the mandrel further comprises wrapping an outer fiberglass layer around the KEVLAR® layer.

8. The method of claim 1, wherein an outer surface of the mandrel corresponds to an inner surface of a fan case.

9. The method of claim 1, further comprising bonding the ice panel segments to an inner surface of a fan case.

10. The method of claim 1, wherein the wrapping the ice panel material around the mandrel comprises applying a tension to the ice panel material.

11. The method of claim 1, wherein the mandrel is substantially cylindrical.

12. A method of manufacturing ice panel segments comprising:
forming a cylinder from an ice panel material; and
cutting the cylinder into ice panel cylinders.

13. The method of claim 12, further comprising cutting the ice panel cylinders into ice panel segments.

14. The method of claim 12, wherein the cylinder is radially cut into the ice panel cylinders.

15. The method of claim 13, wherein the ice panel cylinders are axially cut into the ice panel segments.

16. The method of claim 12, further comprising curing the cylinder.

17. A method of protecting a fan case comprising:
cutting an ice panel cylinder into ice panel segments; and
bonding the ice panel segments to an inner surface of the fan case.

18. The method of claim 17, wherein the ice panel segments are formed by wrapping an ice panel material around a mandrel.

19. The method of claim 17, wherein the ice panel cylinder comprises an inner fiberglass layer, a KEVLAR® layer radially outward from the inner fiberglass layer, and an outer fiberglass layer located radially outward from the KEVLAR® layer.

20. The method of claim 18, wherein the wrapping the ice panel material around the mandrel comprises applying a tension to the ice panel material.
